(19) United States
(12) Patent Application Publication
(10) Pub. No.: US 2016/0136768 A1
(43) Pub. Date: May 19, 2016

(54) MACHINING APPARATUS AND MACHINING METHOD

(71) Applicant: JTEKT CORPORATION, Osaka-shi (JP)

(72) Inventors: Toshiaki NAYA, Hazu-gun (JP); Masahiro IDO, Kariya-shi (JP); Yoshihiro MIZUTANI, Kitanagoya-shi (JP)

(73) Assignee: JTEKT CORPORATION, Osaka-shi (JP)

(21) Appl. No.: 14/937,265

(22) Filed: Nov. 10, 2015

(30) Foreign Application Priority Data
Nov. 17, 2014 (JP) 2014-232768

(51) Int. Cl. B23Q 15/26; G05B 19/19; B23Q 17/22

(52) U.S. Cl. CPC B23Q 15/26; B23Q 17/22; G05B 19/19; G05B 2219/37474

(57) ABSTRACT

A machining apparatus includes: a workpiece spindle having a retainer that retains a workpiece having a noncircular peripheral surface; an adjustment unit that adjusts a retaining force between the workpiece and the retainer; a phase determination member that can determine a phase of the workpiece; and a phase determination detection unit that detects completion of the phase determination. The retaining force is a retaining force for phase determination until the phase determination is completed, and the retaining force is switched to a retaining force for machining which is larger than the retaining force for phase determination after the phase determination is completed.

### INCORPORATION BY REFERENCE

The disclosure of Japanese Patent Application No. 2014-232768 filed on Nov. 17, 2014 including the specification, drawings and abstract, is incorporated herein by reference in its entirety.

### BACKGROUND OF THE INVENTION

1. Field of the Invention

The present invention relates to machining apparatuses and machining methods for noncircular workpieces, and more particularly to phase determination.

2. Description of the Related Art

Machining of a noncircular workpiece need be performed according to the noncircular shape of the workpiece before machining in order to minimize a machining allowance. The noncircular workpiece is therefore machined by moving the workpiece and a tool relative to each other by using a specific phase of the noncircular shape as a machining reference. For example, a technique of setting a phase reference of a camshaft in the case of machining the camshaft as a noncircular workpiece is known in the art. In this technique, the camshaft is attached to a workpiece spindle, and the workpiece spindle having the camshaft attached thereto is rotated. The rotation of the workpiece spindle is stopped when a protruding portion of a cam contacts a phase determination member. An increase in rotational driving force of the workpiece spindle at the time the protruding portion of the cam contacts the phase determination member is detected, whereby completion of phase determination is detected. See Japanese Patent Application Publication No. 2000-246591 (JP 2000-246591 A).

In the technique described in JP 2000-246591 A, the rotation of the workpiece spindle is stopped when the protruding portion of the cam contacts the phase determination member. The rotational driving force of the workpiece spindle is therefore limited to such an extent that the rotational driving force does not break the phase determination member when the protruding portion of the cam contacts the phase determination member. The rotational driving force of the workpiece spindle for machining is also limited. Accordingly, if a machining force becomes larger than the rotational driving force of the workpiece spindle, the rotation of the workpiece spindle is stopped, and machining of the cam shaft may not be able to be performed.

### SUMMARY OF THE INVENTION

It is an object of the present invention to provide a machining apparatus and a machining method which can set a rotational driving force of a workpiece spindle for machining regardless of the strength of a phase determination member.

According to an aspect of the present invention, a machining apparatus includes: a workpiece retainer that retains a workpiece having a noncircular peripheral surface; a workpiece spindle having an attachment portion to which the workpiece retainer is attached; an adjustment unit that adjusts a retaining force between the workpiece and the workpiece retainer; a phase determination member that is placed in a rotation range of the workpiece, and that determines a phase of the workpiece as the workpiece is rotated so that the peripheral surface contacts the phase determination member and the workpiece rotates relative to the workpiece retainer; a phase determination detection unit that detects completion of the phase determination; a control unit that controls the adjustment unit so that the retaining force is a retaining force for phase determination until the phase determination is completed, and the retaining force is switched to a retaining force for machining which is larger than the retaining force for phase determination after the phase determination is completed, and that uses a phase of the workpiece spindle at the time the phase determination is completed as a machining reference phase; and a machining unit that machines the workpiece by using the machining reference phase as a reference.

In the above aspect, control is performed so that the retaining force between the workpiece and the workpiece retainer is the retaining force for phase determination until the phase determination is completed, and the retaining force is switched to the retaining force for machining which is larger than the retaining force for phase determination after the phase determination is completed. Accordingly, a contact force between the peripheral surface and the phase determination member in the case where the workpiece rotates relative to the workpiece retainer at the time of the phase determination can be set to a small value. The workpiece can therefore be reliably held by the large retaining force for machining and does not move in the machining process. As a result, a machining apparatus can be implemented which can machine a workpiece by using the phase of the workpiece spindle at the time the phase determination is completed as the machining reference phase.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic plan view showing the overall configuration of a grinding machine according to an embodiment of the present invention;

FIG. 2 is a diagram as viewed in the direction of arrow A in FIG. 1;

FIG. 3 is a diagram showing a collet chuck;

FIG. 4 is a flowchart showing a phase determination process according to a first embodiment;

FIGS. 5A to 5E are diagrams showing the order of phase determination;

FIG. 6 is a flowchart showing a phase determination process according to a second embodiment; and

FIG. 7 is a diagram showing the order of phase determination.

### DETAILED DESCRIPTION OF EMBODIMENTS

A first embodiment of the present invention will be described below based on an example of a cam grinding machine that grinds the peripheral surface of a plate cam serving as a workpiece having a noncircular peripheral surface.

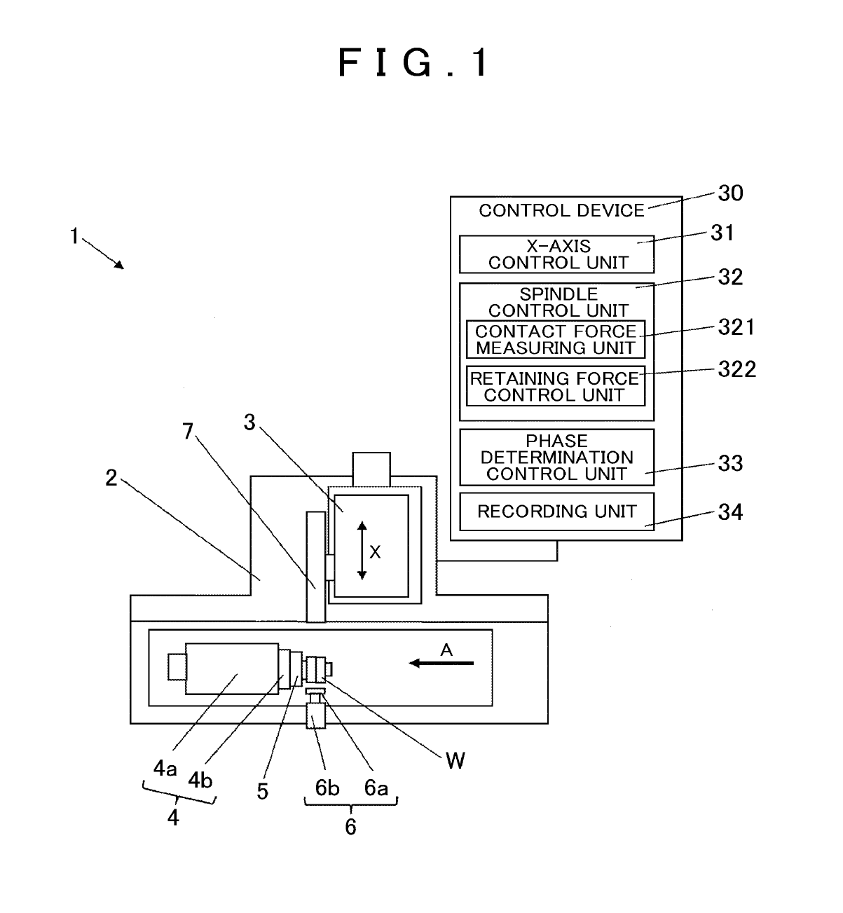

As shown in FIG. 1, a cam grinding machine 1 includes a bed 2 and includes a wheel spindle stock 3 and a workpiece spindle 4 on the bed 2. The wheel spindle stock 3 can reciprocate in the X-axis direction. The wheel spindle stock 3 rotatably supports a grinding wheel 7, and the grinding wheel 7 is rotationally driven by a wheel spindle rotary motor (not shown). The workpiece spindle 4 retains a collet chuck 5 as a workpiece retainer on an end of a spindle 4b rotatably supported by a body 4a. The collet chuck 5 holds the inner peripheral surface of a plate cam W. A phase determination device 6 includes a phase determination member 6a that can be advanced and withdrawn. The phase determination member 6a is placed so as to face all the plate cams W that are held by the collet chuck 5.

The cam grinding machine 1 includes a control device 30. The cam grinding machine 1 includes as a functional configuration of the control device 30 an X-axis control unit 31, a spindle control unit 32, a phase determination control unit 33, and a recording unit 34. The X-axis control unit 31 controls feeding of the wheel spindle stock 3. The spindle control unit 32 controls rotation of the workpiece spindle 4. The phase determination control unit 33 controls advancing and withdrawing movement of the phase determination device 6. The recording unit 34 records a control program and control data therein. The spindle control unit 32 includes a contact force measuring unit 321 and a retaining force control unit 322. The contact force measuring unit 321 measures the contact force between the phase determination member 6a and the plate cam W. The retaining force control unit 322 controls the retaining force of the collet chuck 5.

The control device 30 can perform phase determination and grinding by controlling operation of the wheel spindle stock 3, the workpiece spindle 4, the phase determination device 6, etc. based on control data preset and stored in the recording unit 34.

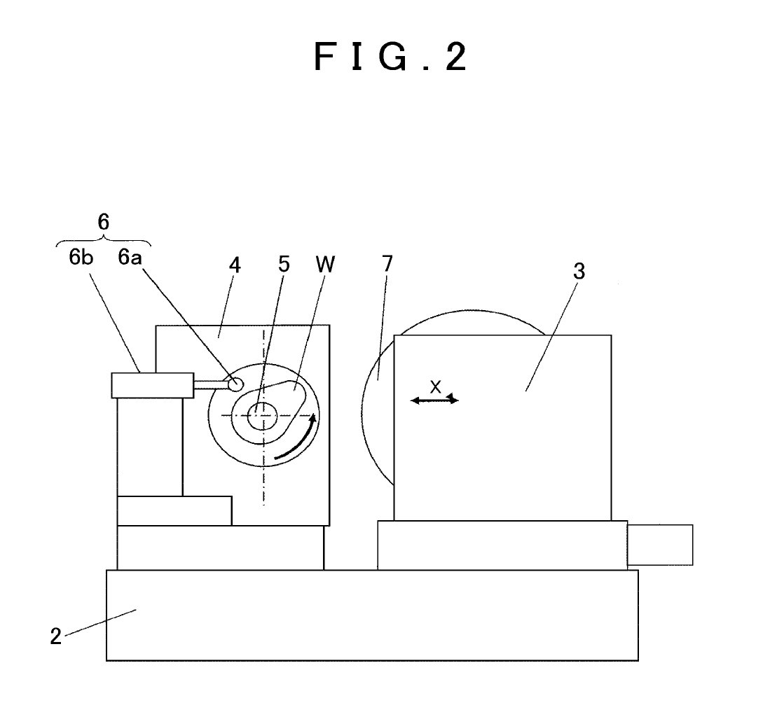

FIG. 2 is a diagram as viewed in the direction of the rotation axis of the workpiece spindle 4. The plate cam W has a protruding portion in a part of its outer peripheral surface, and has a circular inner peripheral surface. The inner peripheral surface of the plate cam W is held by the collet chuck 5, and the plate cam W can rotate about the rotation axis of the workpiece spindle 4. The phase determination device 6 is formed by a body 6b and the phase determination member 6a that can be advanced and withdrawn. When the phase determination member 6a is located at an advanced position, the peripheral surface of the protruding portion of the plate cam W contacts the phase determination member 6a. When the phase determination member 6a is located at a withdrawn position, the peripheral surface of the plate cam W does not contact the phase determination member 6a.

The plate cam W is ground to have a cam shape by placing the plate cam W at a predetermined machining reference phase with respect to the workpiece spindle 4 and then synchronously moving the phase of the spindle 4b of the workpiece spindle 4 and the X-axis feed position of the grinding wheel 7 based on machining data.

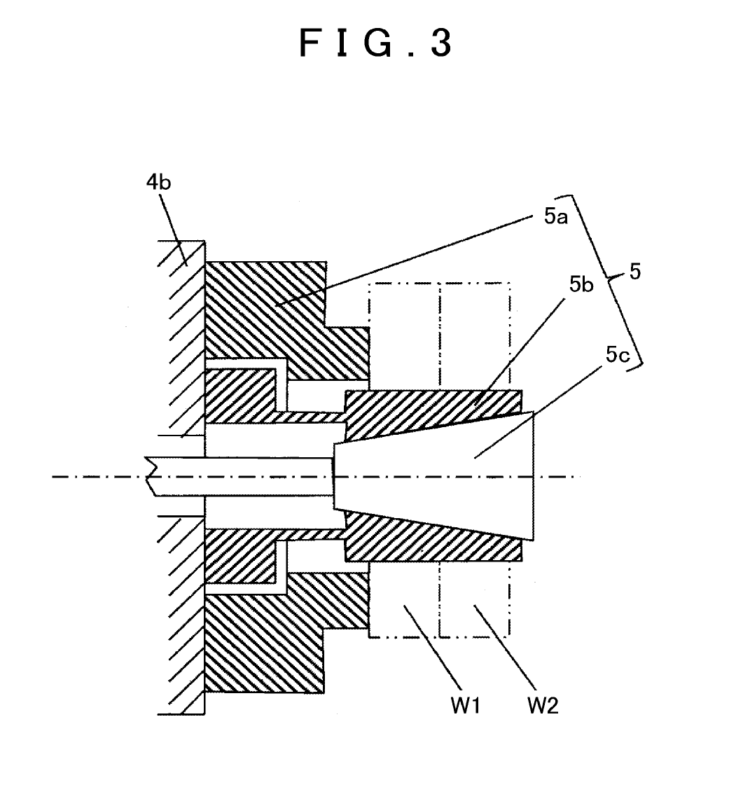

The collet chuck 5 will be described in detail below based on FIG. 3. A thrust reference member 5a is attached to the end of the spindle 4b, and a collet 5b having a tapered inner peripheral surface is placed inward of the thrust reference member 5a. A draw bar 5c is placed in the central portion of the collet chuck 5. The draw bar 5c has at its one end a tapered portion that slides on the tapered inner peripheral surface of the collet 5b. The other end of the draw bar 5c is engaged with a hydraulic cylinder (not shown) placed in the spindle 4b, so that the draw bar 5c can move in the axial direction. Thus, as the draw bar 5c is advanced and withdrawn, the outside diameter of the collet 5b is increased and reduced accordingly, so that the collet 5b can hold and release the inner peripheral surface of the plate cam W. An adjustment unit that adjusts the retaining force between the collet 5b and the plate cam W which is obtained by the collet 5b holding the inner peripheral surface of the plate cam W is the hydraulic cylinder. The retaining force can be set to a desired magnitude by changing the working pressure of the hydraulic cylinder. Such control of the hydraulic cylinder is performed by the retaining force control unit 322.

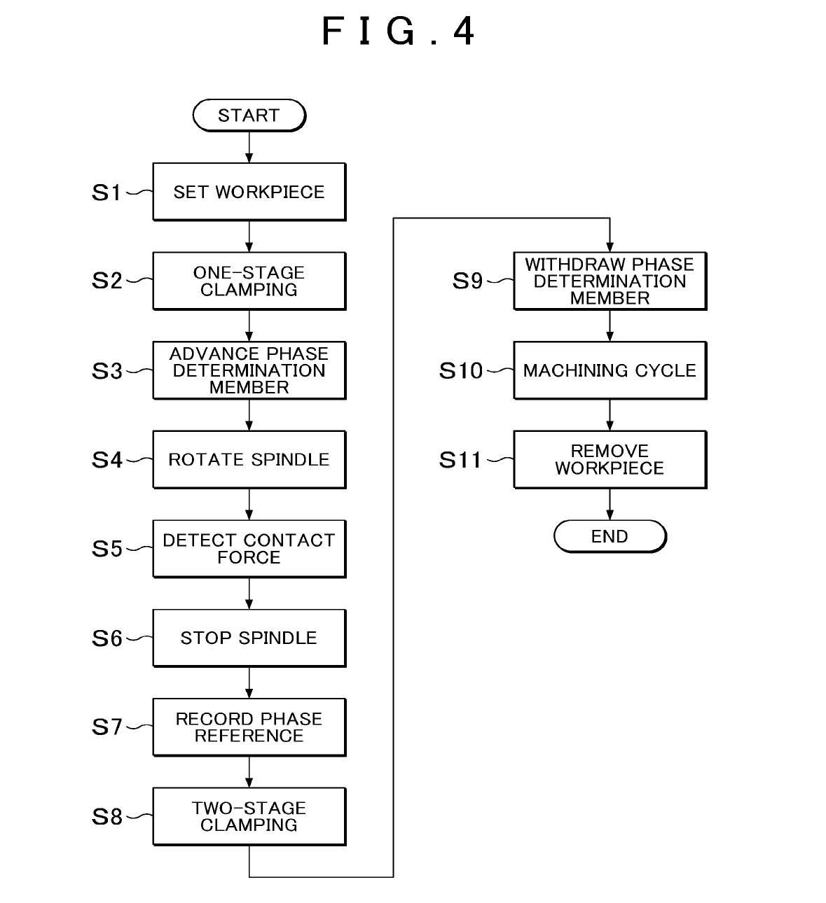

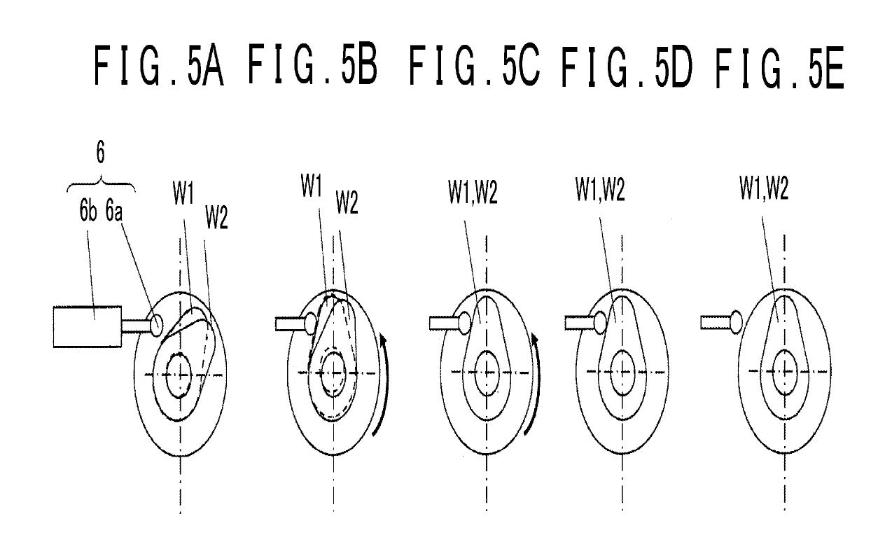

A method for determining the phase of two plate cams W1, W2 will be described in detail below with reference to FIGS. 4 and 5.

First, with the outside diameter of the collet 5b being reduced, the two plate cams W1, W2 are set on the collet 5b and are pressed so that a side surface of the plate cam W1 contacts the thrust reference member 5a (S1). The draw bar 5c is withdrawn by the hydraulic cylinder to increase the outside diameter of the collet 5b so that the collet 5b holds the inner peripheral surfaces of the plate cams W1, W2. One-stage clamping is thus completed. At this time, the pressure of the hydraulic cylinder is P1, and the force by which the collet 5b holds and retains the plate cams W1, W2 is a retaining force for phase determination (S2). The phase determination member 6a is advanced (S3). FIG. 5A shows the positional relationship between the phase determination member 6a and the two plate cams W1, W2 at this time.

When the spindle 4b is rotated, the plate cam W1 contacts the phase determination member 6a as shown in FIG. 5B, and the plate cam W1 and the collet 5b rotate relative to each other. A sliding friction force is thus generated, whereby torque for rotating the spindle 4b increases (S4). The spindle 4b is further rotated, and the plate cam W2 contacts the phase determination member 6a as shown in FIG. 5C. The two plate cams W1, W2 and the collet 5b rotate relative to each other while sliding on each other, whereby the friction force increases. The torque for rotating the spindle 4b therefore further increases. When the torque becomes larger than determination torque serving as a determination contact force, contact is detected by a contact force detection unit. Specifically, the determination torque is detected by the contact force measuring unit 321 when a current value of a motor that rotates the spindle 4b becomes larger than a predetermined determination current value. The value of the determination torque is larger than friction torque that is generated when the single plate cam W1 slides and is smaller than friction torque that is generated when the two plate cams W1, W2 slide (S5).

Subsequently, the rotation of the spindle 4b is stopped, whereby a phase determination detection unit detects completion of phase determination. FIG. 5D shows the positional relationship between the phase determination member 6a and the two cam plates W1, W2 at this time. The plate cams W 1, W2 are in phase with each other (S6). The current rotation phase of the spindle 4b is recorded as a reference phase Sk in the recording unit 34 (S7). The pressure of the hydraulic cylinder is increased to P2 higher than P1 to perform two-stage clamping. The force with which the collet 5b holds and retains the plate cams W1, W2 is a retaining force for machining (S8). The phase determination member 6a is withdrawn (S9). Thereafter, rotation of the spindle 4b using as the origin a machining reference computed based on the reference phase Sk is synchronized with advancing and withdrawing movement of the grinding wheel 7 to perform a machining cycle of grinding the outer periphery of the cam to a desired shape (S10). The draw bar 5c is advanced by the hydraulic cylinder to reduce the outside diameter of the collet 5b, and the workpiece is removed in this state (S11).

As described above, by using the method of the first embodiment, the two plate cams W1, W2 are rotated relative to the collet 5b with a weak retaining force so that the two cams W1, W2 are in phase with each other. After the phase determination, the retaining force for the plate cams is increased. In this state, rotation of the spindle 4b is synchronized with advancing and withdrawing movement of the grinding wheel 7. The two plate cams W1, W2 can thus be ground at the same time. The retaining force during phase determination of the plate cams W1, W2 is weak regardless of the rotational driving force of the spindle 4b. Accordingly, the force that is applied to the phase determination member 6a can be reduced, and deformation or breakage of the phase determination member 6a can be prevented. Since the retaining force is increased when grinding the plate cams W1, W2, slipping of the plate cams W1, W2 due to grinding resistance can be prevented, and efficient grinding can be implemented up to the maximum rotational driving force of the spindle 4b.

Any number of plate cams can be used, and the phase determination member 6a is placed to face all the plate cams held by the collet 5b so that the phase determination member 6a can contact all the plate cams. The determination current value may be any value corresponding to sliding resistance, which is larger than the sliding friction resistance at the time a number of plate cams one less than the total number of plate cams slide and is smaller than the sliding friction resistance at the time all the plate cams slide.

A second embodiment of the present invention will be described below.

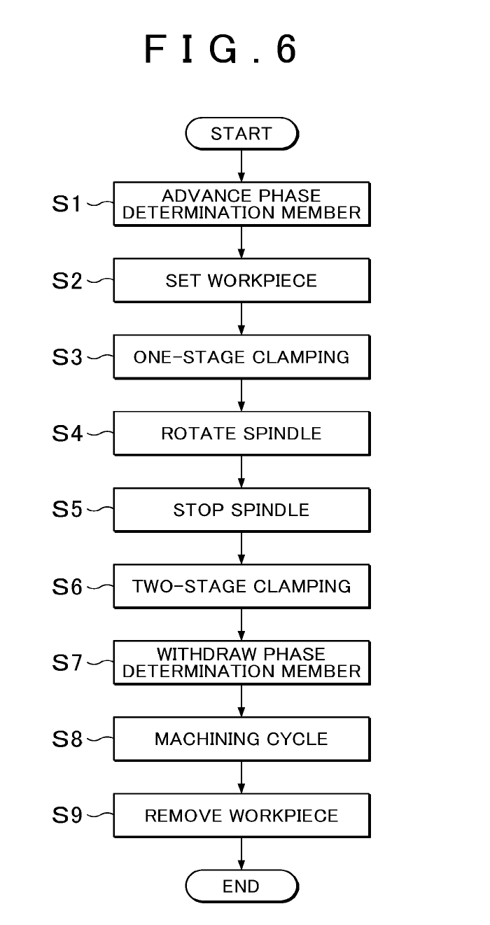

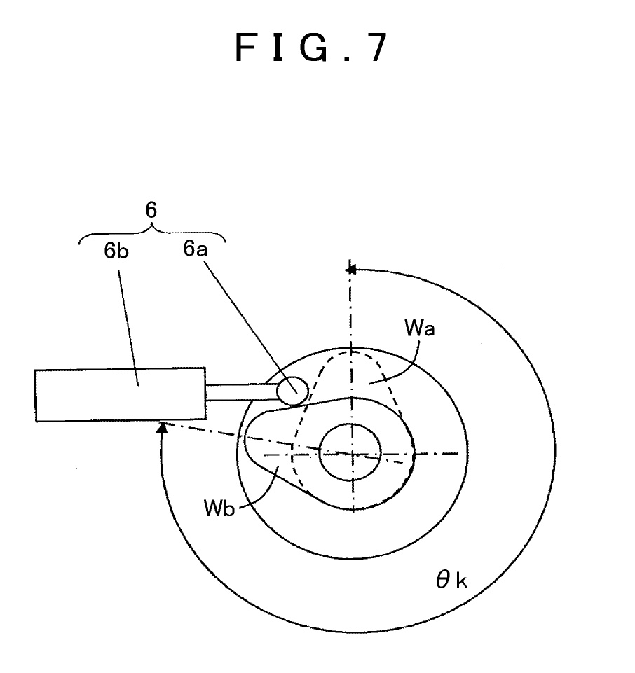

A cam grinding machine of the second embodiment has the same structure as that of the first embodiment except that the contact force detection unit is eliminated, and uses a different phase determination method from that of the first embodiment. A method for determining the phase of the plate cam W will be described in detail below with reference to FIGS. 6 and 7.

First, the phase determination member 6a is advanced. At this time, the collet 5b has a reduced outside diameter (S1). The two plate cams W1, W2 are set on the collet 5b and are pressed so that the side surface of the plate cam W1 contacts the thrust reference member 5a. Since the phase determination member 6a has been advanced, the two plate cams W1, W2 can be set in the range of an angle Θk where the protruding portion of the cam and the phase determination member 6a do not interfere with each other as shown in FIG. 7 (S2). The draw bar 5c is withdrawn by the hydraulic cylinder to increase the outside diameter of the collet 5b so that the collet 5b holds the inner peripheral surfaces of the plate cams W1, W2. One-stage clamping is thus completed. At this time, the pressure of the hydraulic cylinder is P1, and the force by which the collet 5b holds and retains the plate cams W1, W2 is a retaining force for phase determination (S3).

The spindle 4b is rotated counterclockwise by a predetermined phase determination angle equal to or larger than a rotation limit angle. As used herein, the term “rotation limit angle” refers to the rotation limit angle of the plate cam W where the plate cam W does not interfere with the phase determination member 6a in the state where the phase determination member 6a is advanced, as shown in FIG. 7. The rotation limit angle is therefore the angle Θk. When the plate cams W1, W2 are set on the collet 5b, the plate cams W1, W2 are held so that the phase of the plate cams W1, W2 is in the range of the angle Θk. Accordingly, when the spindle 4b is rotated counterclockwise by the phase determination angle, the plate cams W1, W2 always contact the phase determination member 6a and have a phase Wa (S4). The rotation of the spindle 4b is stopped and completion of phase determination is detected. FIG. 5D shows the positional relationship between the phase determination member 6a and the two plate cams W1, W2 at this time. The plate cams W1, W2 have the same phase, namely the reference phase Sk (S5). The pressure of the hydraulic cylinder is increased to P2 higher than P1 to perform two-stage clamping. The force by which the collet 5b holds and retains the plate cams W1, W2 is a retaining force for machining (S6). The phase determination member 6a is withdrawn (S7). Thereafter, rotation of the spindle 4b using as the origin a machining reference computed based on the reference phase Sk is synchronized with advancing and withdrawing movement of the grinding wheel 7 to perform a machining cycle of grinding the outer periphery of the cam to a desired shape (S8). The draw bar 5c is advanced by the hydraulic cylinder to reduce the outside diameter of the collet 5b, and the workpiece is removed in this state (S9).

As described above, in the second embodiment, the two plate cams W1, W2 are rotated relative to the collet 5b with a weak retaining force so that the two cams W1, W2 are in phase with each other. After the phase determination, the retaining force for the plate cams is increased. In this state, rotation of the spindle 4b is synchronized with advancing and withdrawing movement of the grinding wheel 7. The two plate cams W1, W2 can thus be ground at the same time. The retaining force during phase determination of the plate cams W1, W2 is weak regardless of the rotational driving force of the spindle 4b. Accordingly, the force that is applied to the phase determination member 6a can be reduced, and deformation or breakage of the phase determination member 6a can be prevented. Since the retaining force is increased when grinding the plate cams W1, W2, slipping of the plate cams W1, W2 due to grinding resistance can be prevented, and efficient grinding can be implemented up to the maximum rotational driving force of the spindle 4b.

Moreover, since phase determination can be carried out without requiring the contact force detection unit, a simple, low cost grinding machine can be implemented.

Although the embodiments of the grinding process for plate cams are described above, the grinding process may be used for any workpiece having a noncircular peripheral surface as long as the workpiece is machined while being rotated. The present invention may be applied to a cutting process.

What is claimed is:

1. A machining apparatus, comprising:
a workpiece retainer that retains a workpiece having a noncircular peripheral surface;
a workpiece spindle having an attachment portion to which the workpiece retainer is attached;
an adjustment unit that adjusts a retaining force between the workpiece and the workpiece retainer;
a phase determination member that is placed in a rotation range of the workpiece, and that determines a phase of the workpiece as the workpiece is rotated so that the peripheral surface contacts the phase determination member and the workpiece rotates relative to the workpiece retainer;
a phase determination detection unit that detects completion of the phase determination;
a control unit that controls the adjustment unit so that the retaining force is a retaining force for phase determination until the phase determination is completed, and the retaining force is switched to a retaining force for machining which is larger than the retaining force for phase determination after the phase determination is completed, and that uses a phase of the workpiece spindle at the time the phase determination is completed as a machining reference phase; and
a machining unit that machines the workpiece by using the machining reference phase as a reference.

2. The machining apparatus according to claim 1, further comprising:
a contact force detection unit that detects a contact force between the peripheral surface and the phase determination member; wherein
the phase determination detection unit detects the completion of the phase determination when rotation of the workpiece spindle is stopped after the contact force detection unit detects the contact force that is larger than a determination contact force,
the workpiece retainer retains a plurality of the workpieces, and
the determination contact force is smaller than a friction force that is generated by relative rotation between the workpiece retainer and all the workpieces retained by the workpiece retainer, and is larger than a friction force that is generated by relative rotation between the workpiece retainer and the total number of workpieces minus one workpiece.

3. The machining apparatus according to claim 2, wherein
the contact force detection unit detects the contact force by detecting a current value of a rotational drive motor for the workpiece spindle.

4. The machining apparatus according to claim 1, wherein
the phase determination detection unit detects the completion of the phase determination when the phase determination member is placed in the rotation range of the workpiece and rotation of the workpiece spindle is stopped after the workpiece spindle is rotated by a rotation limit angle or more, and
the rotation limit angle is a rotation angle of the workpiece where the workpiece does not interfere with the phase determination member placed in the rotation range of the workpiece.

5. The machining apparatus according to claim 1, wherein
the workpiece retainer is a collet chuck that holds an inner periphery of the workpiece.

6. A machining method, wherein
a workpiece having a noncircular peripheral surface is machined by the machining apparatus according to claim 1.
